(19) United States
(12) Patent Application Publication
(10) Pub. No.: US 2020/0001491 A1
(43) Pub. Date: Jan. 2, 2020

(54) PUNCTURING DEVICE FOR A PAINT CAN RIM

(71) Applicant: Jackie Attkisson, Columbia, TN (US)

(72) Inventor: Jackie Attkisson, Columbia, TN (US)

(21) Appl. No.: 16/025,816

(22) Filed: Jul. 2, 2018

(51) Int. Cl. B26F 1/14

(52) U.S. Cl. CPC B26F 1/14

(57) ABSTRACT

A puncturing device for a rim of a paint can, the puncturing device including a main body having a shape to correspond to the rim of the paint can, and a plurality of spikes to extend perpendicularly away from a bottom surface of the main body.

### BACKGROUND

### 1. Field

The present general inventive concept relates generally to a paint can rim puncturing device.

### 2. Description of the Related Art

After a paint can is opened, a painter typically dunks a paint brush in the paint can and pulls it out to drag it across the edge (i.e., the rim) along the top of the can. This action leaves paint in the rim of the can, and once it is time to close the lid, the rim is full of paint leading to a mess.

Therefore, there is a need for an efficient solution to the paint can rim mess problem.

### SUMMARY

The present general inventive concept provides a paint can rim puncturing device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a puncturing device for a rim of a paint can, the puncturing device including a main body having a shape to correspond to the rim of the paint can, and a plurality of spikes to extend perpendicularly away from a bottom surface of the main body.

The plurality of spikes may be disposed from each other at distances between 1 MM and 20 MM.

The plurality of spikes may be sharp and durable to puncture an inner portion of the rim of the paint can.

Each of the plurality of spikes may have at least one of a pyramidal shape and a conical shape.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a puncturing device for a rim of a paint can, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

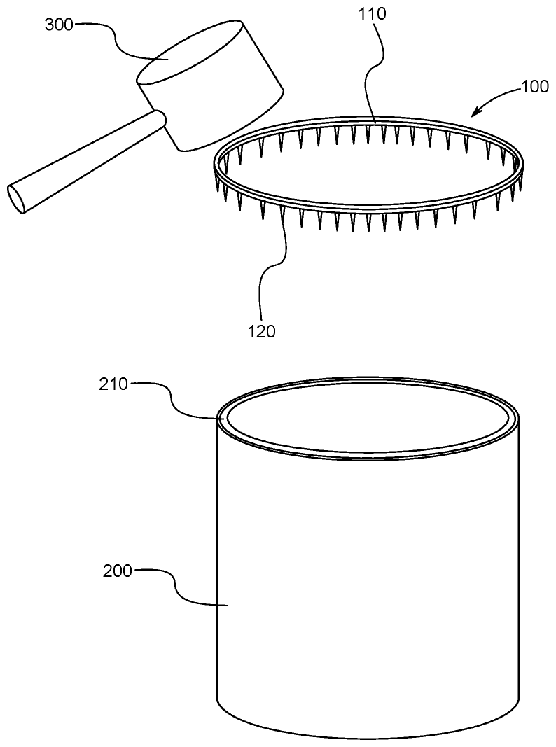

FIG. 1 illustrates a puncturing device 100 for a rim 210 of a paint can 200, according to an exemplary embodiment of the present general inventive concept.

The puncturing device 100 may be designed to fit into a rim of any conventional paint can, and may be constructed from metal, plastic, rubber, wood, etc., but is not limited thereto.

As illustrated in FIG. 1, the puncturing device 100 may include a main body 110 and a plurality of spikes 120, but is not limited thereto.

The main body 110 may have may have a substantially round (i.e., circular) shape, in order to be able to correspond properly to the rim 210 of the paint can 200.

The plurality of spikes 120 may be disposed at a bottom portion of the main body 110 to extend perpendicularly away therefrom, and may be pointed and sharp in order to be able to puncture an inner surface of the rim 210.

Each of the plurality of spikes 120 may be between 1 MM and 20 MM in length, and may be disposed from each other at distances between 1 MM and 20 MM.

Each of the plurality of spikes may have at least one of a pyramidal shape and a conical shape.

When the plurality of spikes 120 are placed within the rim 210 of the paint can 200, a mallet 300 may be used to hammer a top portion of the main body 110 such that the plurality of spikes 120 may puncture an inner portion of the rim 210.

When the puncturing device 100 is removed from the rim 210 of the paint can 200, holes remain within the rim 210, in order to allow any paint accumulated within the rim 210 to drain back into the paint can 200.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A puncturing device for a rim of a paint can, the puncturing device comprising:
a main body having a shape to correspond to the rim of the paint can; and
a plurality of spikes to extend perpendicularly away from a bottom surface of the main body.

2. The puncturing device of claim 1, wherein the plurality of spikes are disposed from each other at distances between 1 MM and 20 MM.

3. The puncturing device of claim 1, wherein the plurality of spikes are sharp and durable to puncture an inner portion of the rim of the paint can.

4. The puncturing device of claim 1, wherein each of the plurality of spikes has at least one of a pyramidal shape and a conical shape.
